(19) United States
(12) Patent Application Publication
(10) Pub. No.: US 2018/0044201 A1
(43) Pub. Date: Feb. 15, 2018

(54) LIQUID CONTAINERS HAVING FILTERS AND RELATED METHODS

(71) Applicant: Aquasana, Inc., Austin, TX (US)

(72) Inventors: Paul Metaxatos, Austin, TX (US); Joel Nevin, Austin, TX (US); Steffen Koury, Austin, TX (US); Nicholas Varjabedian, Austin, TX (US); Brendan Crawford, Austin, TX (US)

(21) Appl. No.: 15/555,879

(22) PCT Filed: Mar. 4, 2016
(86) PCT No.: PCT/US16/20821

§ 371 Date: Sep. 5, 2017

Related U.S. Application Data
(60) Provisional application No. 62/129,739, filed on Mar. 6, 2015.

(51) Int. Cl. C02F 1/00; A45F 3/20; A45F 3/18; B65D 47/06; B65D 51/28; C02F 1/28; B65D 41/02

(52) U.S. Cl. CPC C02F 1/002; C02F 1/283; A45F 3/20; B65D 41/02; B65D 47/06; B65D 51/28; A45F 3/18; C02F 2307/02; A45F 2003/163

(57) ABSTRACT

Some of the present containers include a bottle defining a mouth in fluid communication with an interior volume, a cap configured to at least partially cover the mouth and defining an outlet in fluid communication with the interior volume, and a filter assembly configured to filter liquid communicated between the interior volume and the outlet, the filter assembly having a first end, a second end, and a housing extending between the first and second ends to define an interior passageway configured to contain a filter having an upper end cap defining an opening, a lower end cap, and a filter media extending between the upper and lower end caps. In some containers, the filter assembly is configured to be coupled to the cap with the opening in fluid communication with the outlet. Some containers include a straw configured to be coupled in fluid communication between the outlet and the opening.

### CROSS REFERENCE TO RELATED APPLICATIONS

This application claims the benefit of U.S. Provisional Application No. 62/129,739, filed Mar. 6, 2015, which is incorporated by reference herein.

### BACKGROUND

### 1. Field of Invention

The present invention relates generally to liquid containers, and more specifically, but not by way of limitation, to liquid containers, such as water and/or sport bottles, having filters.

### 2. Description of Related Art

Liquid containers, such as water and/or sport bottles, are often used as portable sources of liquid, such as water, for human consumption. Such liquid containers are typically filled with liquid from a liquid source prior to use.

However, such liquid sources may provide liquid containing contaminants. For example, water from a tap may contain microorganisms, disinfectants, disinfection byproducts, chemicals, radionuclides, and/or the like, which, in some instances, may be hazardous for human consumption. Therefore, some liquid containers include a filter configured to filter liquid within the liquid container prior to human consumption of the liquid.

### SUMMARY

Some embodiments of the present liquid containers are configured, through a plurality of apertures defined by a housing of a filter assembly configured to contain a filter, each of the plurality of apertures having a minimum transverse dimension larger than a minimum transverse dimension of an outlet of the liquid container, to, for example, mitigate flow restrictions in liquid flow through the filter while retaining the filter within the housing.

Some embodiments of the present liquid containers are configured, through a straw configured to be in fluid communication between an outlet of the liquid container and a filter such that the straw extends into the filter and is spaced apart from an innermost surface of a filter media of the filter, to, for example, provide for substantially radial liquid flow, as opposed to axial liquid flow, through the filter media, reduce a pressure differential required for liquid flow through the filter media, and/or the like.

Some embodiments of the present liquid containers comprise: a bottle having a sidewall defining an interior volume configured to hold liquid and a mouth in fluid communication with the interior volume, a cap defining a recess configured to receive a portion of the bottle to cover at least a portion of the mouth, the cap defining an outlet in fluid communication with the interior volume, and a filter assembly configured to filter liquid communicated between the interior volume and the outlet, the filter assembly having: a first end, a second end, and a housing extending from the first end to the second end to define an interior passageway configured to contain a filter having: an upper end cap defining an opening, a lower end cap, and a filter media extending between the upper end cap and the lower end cap, and a straw configured to be coupled in fluid communication between the outlet and the opening such that the straw extends into the interior passageway of the housing. In some embodiments, the straw is configured to extend through the upper end cap of the filter such that the straw is spaced apart from an innermost surface of the filter media.

In some embodiments, the housing between the first end and the second end defines a plurality of apertures in fluid communication with the interior passageway. In some embodiments, each of the plurality of apertures comprises a substantially circular cross-section. In some embodiments, each of the plurality of apertures has a minimum transverse dimension larger than a minimum transverse dimension of the outlet. In some embodiments, the interior passageway of the housing is configured to contain the filter such that the second end of the filter assembly is substantially closed.

In some embodiments, the filter comprises a first fitting extending away from the upper end cap and surrounding the opening, the first fitting defining one or more annular grooves, each configured to receive an O-ring, and the first fitting is configured to be coupled to the straw. In some embodiments, the first fitting is configured to be received by the straw. In some embodiments, the cap comprises a second fitting extending away from the recess and surrounding the outlet, the second fitting defining one or more annular grooves, each configured to receive an O-ring, and the second fitting is configured to be coupled to the straw. In some embodiments, the second fitting is configured to be received by the straw. In some embodiments, the straw is unitary with at least a portion of the housing.

Some embodiments of the present liquid containers comprise: a bottle having a sidewall defining an interior volume configured to hold liquid and a mouth in fluid communication with the interior volume, a cap defining a recess configured to receive a portion of the bottle to cover at least a portion of the mouth, the cap defining an outlet in fluid communication with the interior volume, and a filter assembly configured to filter liquid communicated between the interior volume and the outlet, the filter assembly having: a first end, a second end, and a housing extending from the first end to the second end to define an interior passageway configured to contain a filter having: an upper end cap defining an opening, a lower end cap, and a filter media extending between the upper end cap and the lower end cap, where the housing between the first end and the second end defines a plurality of apertures in fluid communication with the interior passageway, each of the plurality of apertures having a minimum transverse dimension larger than a minimum transverse dimension of the outlet, where the filter assembly is configured to be coupled to the cap such that the opening of the filter is in fluid communication with the outlet.

In some embodiments, each of the plurality of apertures comprises a substantially circular cross-section. In some embodiments, the interior passageway of the housing is configured to contain the filter such that the second end of the filter assembly is closed.

In some embodiments, the filter comprises a first fitting extending away from the upper end cap and surrounding the opening, the first fitting defining one or more annular grooves, each configured to receive an O-ring, and the first fitting is configured to be coupled to the cap. In some embodiments, the cap comprises a second fitting extending away from the recess and surrounding the outlet, the second fitting defining one or more annular grooves, each configured to receive an O-ring, and the second fitting is configured to be coupled to the upper end cap of the filter. In some embodiments, the first end of the filter assembly is configured to be press-fit to the cap. In some embodiments, the first end of the filter assembly is configured to be threadably coupled to the cap.

In some embodiments of the present liquid containers, the housing of the filter assembly is substantially cylindrical. In some embodiments, the housing of the filter assembly is spaced apart from the sidewall of the bottle. In some embodiments, the interior passageway of the housing is configured to contain the filter such that the filter media is spaced apart from the housing.

Some embodiments comprise the filter. In some embodiments, at least a portion of the filter is unitary with at least a portion of the housing of the filter assembly. In some embodiments, the lower end cap of the filter is closed. In some embodiments, the upper end cap of the filter and the lower end cap of the filter each define a recess configured to receive at least a portion of the filter media. In some embodiments, the recess of each of the upper end cap and the lower end cap is annular.

In some embodiments, the filter media has a nominal pore size of less than 0.5 micron. In some embodiments, the filter media comprises pleated fabric. In some embodiments, the pleated fabric comprises carbon.

In some embodiments, the cap is configured to be threadably coupled to the bottle. In some embodiments, the cap comprises a vent configured to adjust an internal pressure of the bottle. In some embodiments, the cap comprises a mouth piece in fluid communication with the outlet. In some embodiments, the mouth piece is laterally offset from the outlet. Some embodiments comprise a lid pivotally coupled to the cap, the lid configured to selectively cover the outlet.

Some embodiments of the present methods comprise: providing a filter having an upper end cap defining an opening, a lower end cap, and a filter media extending between the upper end cap and the lower end cap to define an inner volume, disposing a straw through the opening and into the inner volume such that the straw is spaced apart from an innermost surface of the filter media, disposing the filter through a mouth of a bottle and into an interior volume of the bottle, and disposing a cap defining an outlet over at least a portion of the mouth such that the outlet is in fluid communication with the straw.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” may be substituted with “within [a percentage] of” what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1A is a perspective view of a first embodiment of the present liquid containers.

FIGS. 1B and 1C are front and back views, respectively, of the embodiment of FIG. 1A.

FIGS. 1D and 1E are opposing side views of the embodiment of FIG. 1A.

FIGS. 1F and 1G are top and bottom views, respectively, of the embodiment of FIG. 1A.

FIG. 1H is a cross-sectional side view of the embodiment of FIG. 1A.

FIG. 1I is an exploded perspective view of the embodiment of FIG. 1A.

FIG. 1J is a cross-sectional top view of the embodiment of FIG. 1A.

FIG. 2A is a cross-sectional side view of a second embodiment of the present liquid containers.

FIG. 2B is an exploded perspective view of the embodiment of FIG. 2A.

### DETAILED DESCRIPTION OF ILLUSTRATIVE EMBODIMENTS

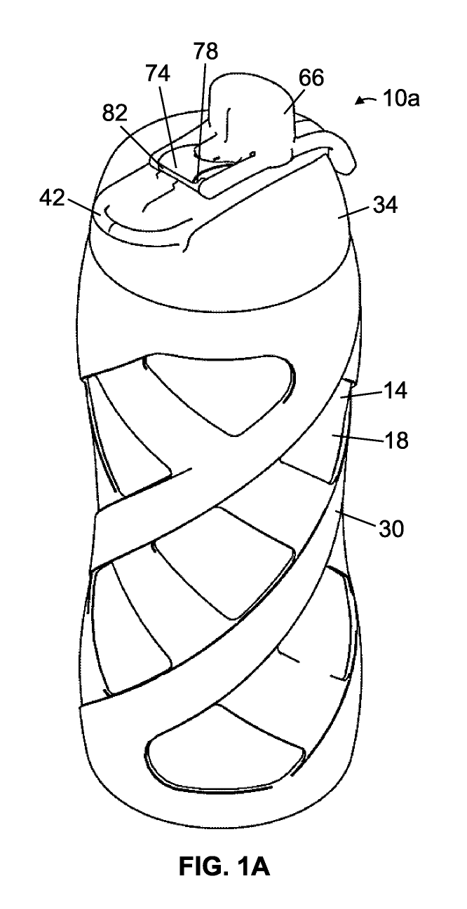

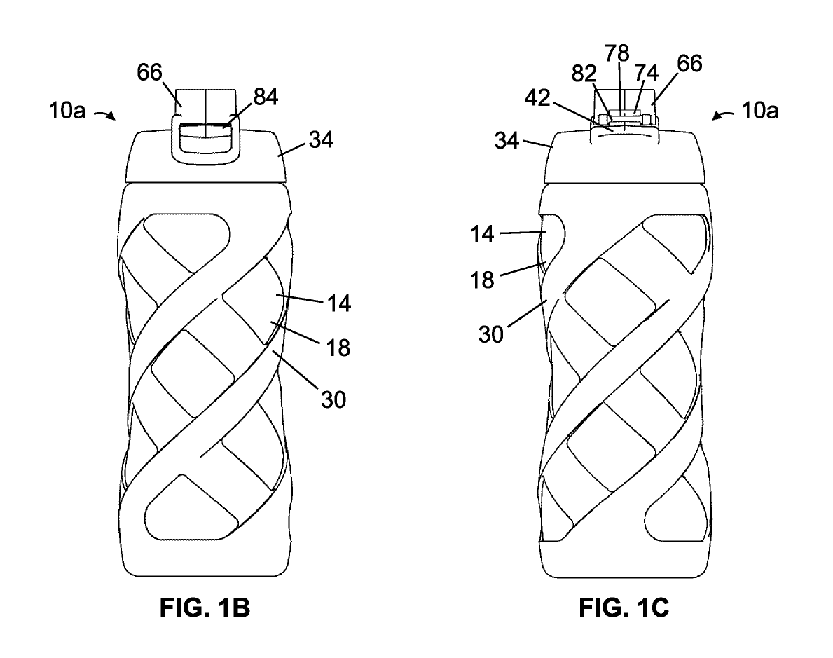

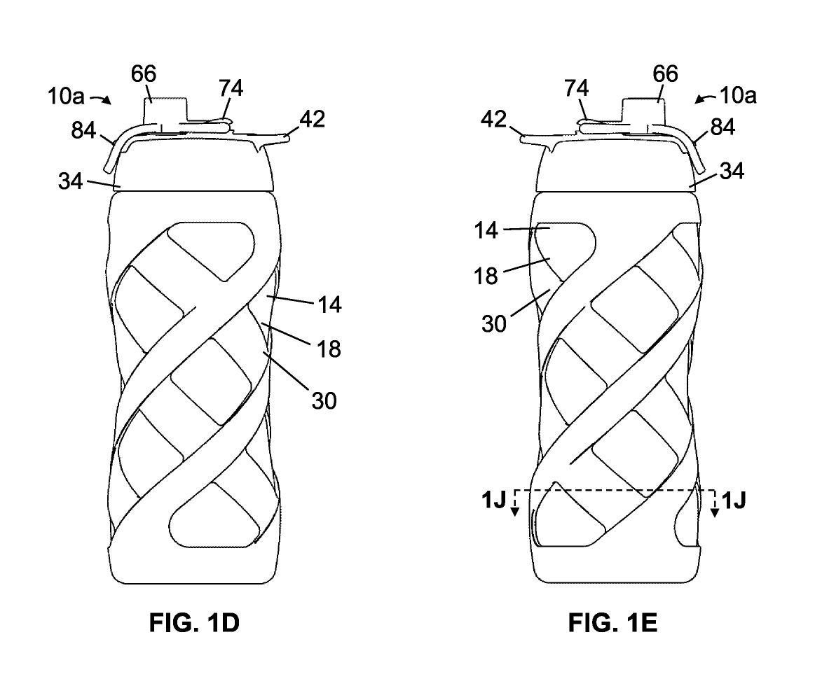

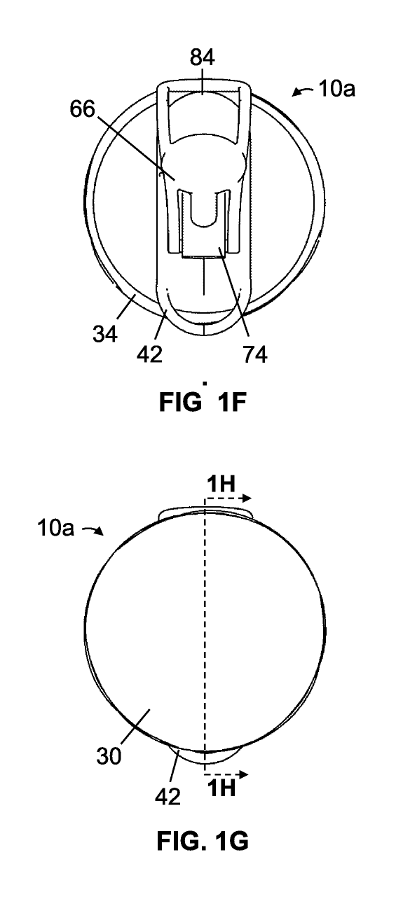

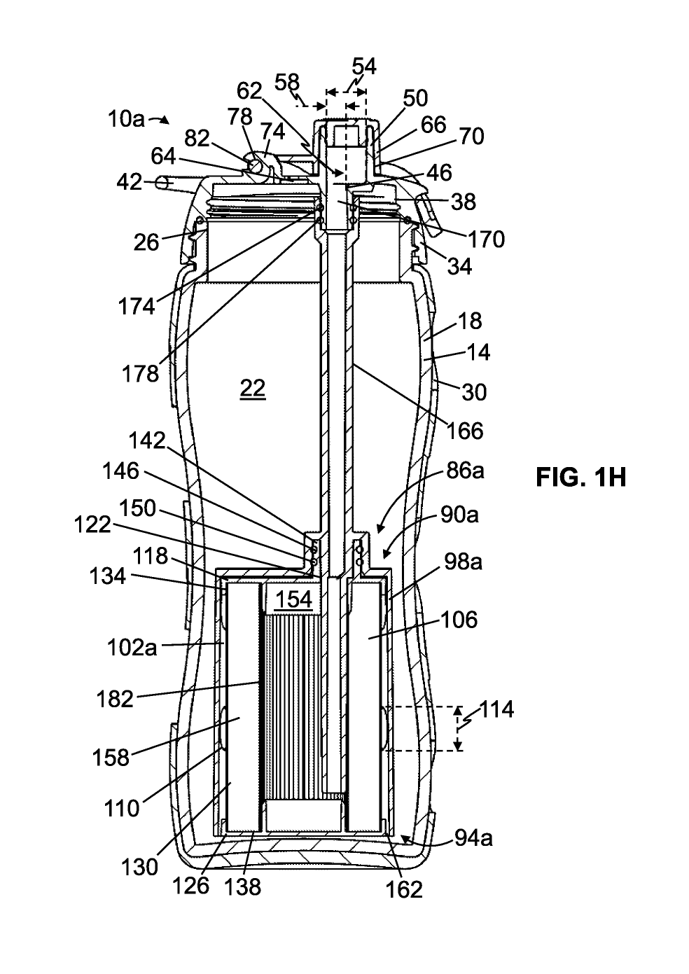

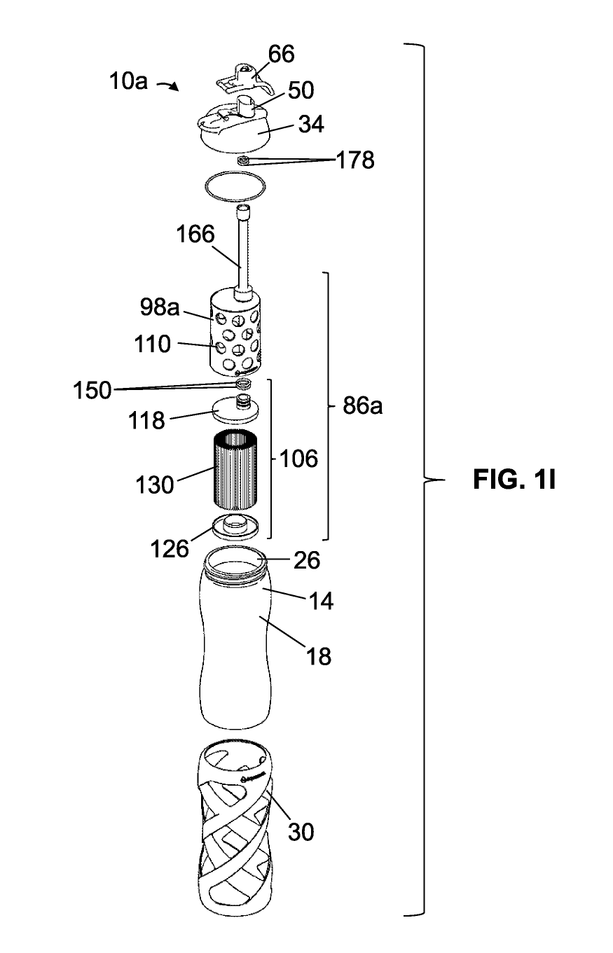

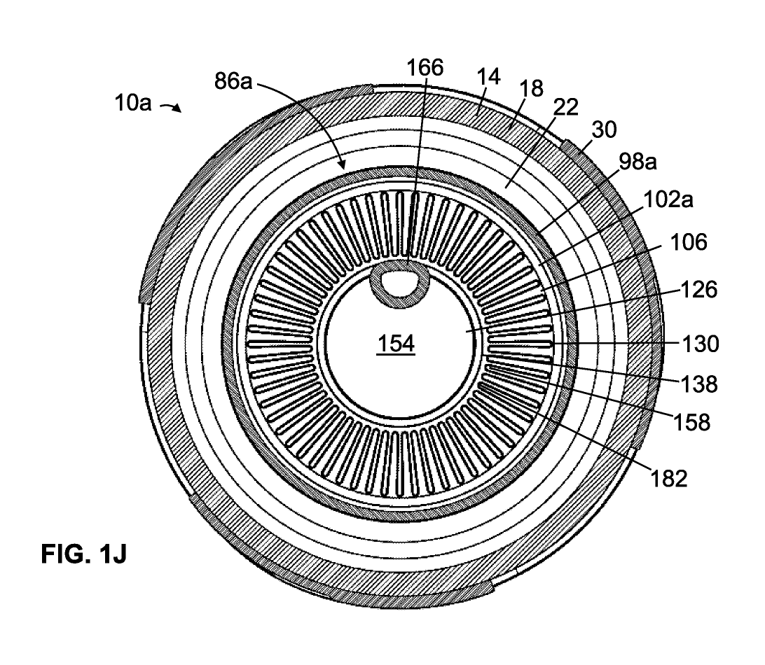

Referring now to the drawings, and more particularly to FIGS. 1A-1J, shown therein and designated by the reference numeral 10a is a first embodiment of the present liquid containers. In the embodiment shown, liquid container 10a comprises a bottle 14 configured to hold liquid. The present liquid containers may be configured to hold any suitable liquid, such as, for example, water (whether flavored or unflavored), sports drinks, and/or the like. For example, in this embodiment, bottle 14 has a sidewall 18 defining an interior volume 22 (FIG. 1H) configured to hold liquid and a mouth 26 in fluid communication with the interior volume. In the depicted embodiment, bottle 14 comprises glass; however, in other embodiments, respective bottles (e.g., 14) may comprise any suitable material, such as, for example, plastic, metal, and/or the like. In the embodiment shown, bottle 14 is rigid; however, in other embodiments, respective bottles (e.g., 14) may comprise respective sidewalls (e.g., 18) having flexible portions (e.g., and such respective bottles may be squeezable).

In this embodiment, liquid container 10a comprises a sleeve 30, which may be disposed over exterior surfaces of bottle 14. As shown, in the depicted embodiment, sleeve 30 is flexible such that the sleeve may conform to exterior surfaces of bottle 14 when the sleeve is disposed over the exterior surfaces of the bottle. In the embodiment shown, sleeve 30 comprises silicone; however, in other embodiments, respective sleeves (e.g., 30) may comprise any suitable material, such as, for example, rubber, nitrile, vinyl, neoprene, and/or the like. In at least this way, respective sleeves (e.g., 30) of embodiments of the present liquid containers may protect respective bottles (e.g., 14) from damage, thermally insulate the respective bottles, provide an anti-slip surface for a user to grasp, and/or the like.

In this embodiment, liquid container 10a comprises a cap 34 configured to be coupled to bottle 14 such that the cap covers at least a portion of (e.g., up to and including all of) mouth 26. For example, in the depicted embodiment, cap 34 defines a recess 38 configured to receive a portion of bottle 14 (e.g., a portion of sidewall 18 that defines mouth 26) to cover at least a portion of mouth 26. In the embodiment shown, cap 34 comprises plastic; however, in other embodiments, respective caps (e.g., 34) may comprise any suitable material, such as, for example, metal, and/or the like. In this embodiment, cap 34 is configured to be threadably coupled to bottle 14 (e.g., as shown, via threads on bottle 14 and cap 34), and such coupling between the cap and the bottle may be sealed (e.g., by an O-ring); however, in other embodiments, respective caps (e.g., 34) can be coupled to respective bottles (e.g., 14) in any suitable fashion, such as, for example, via a press-fit, snap-fit, interlocking features of the respective caps and/or the respective bottles, and/or the like. In the depicted embodiment, liquid container 10a comprises a handle 42 (e.g., coupled to cap 34, integrally formed with the cap, and/or the like) (e.g., to facilitate a user in carrying liquid container 10a).

In the embodiment shown, cap 34 defines an outlet 46 in fluid communication with interior volume 22. In this embodiment, cap 34 comprises an open mouth piece 50 extending from the cap opposite recess 38 and in fluid communication with (e.g., surrounding) outlet 46. In the depicted embodiment, open mouth piece 50 has a minimum interior transverse dimension 54 larger than a minimum transverse dimension 58 of outlet 46. In the embodiment shown, mouth piece 50 is laterally offset (e.g., in a direction indicated by arrow 62) from outlet 46 (e.g., an opening of open mouth piece 50 is off-center from, non-coaxial with, and/or does not share a longitudinal axis with, outlet 46). In this embodiment, cap 34 comprises a vent 64 (e.g., a one-way valve) configured to adjust an internal pressure of bottle 14 (e.g., by allowing air to enter interior volume 22 as liquid leaves the interior volume).

In the depicted embodiment, liquid container 10a comprises a lid 66 pivotally coupled to cap 34 and configured to selectively cover outlet 46. For example, in the embodiment shown, lid 66 defines a recess 70 configured to receive mouth piece 50 when the lid is in the closed position (FIG. 1H) to cover outlet 46. In this embodiment, lid 66 is pivotally coupled to cap 34 at a hinge 74. In the depicted embodiment, hinge 74 comprises a bearing 78 (e.g., defined by cap 34) and a pin 82 (e.g., defined by lid 66) rotatably received by the bearing. However, in other embodiments, respective hinges (e.g., 74) can comprise any suitable structure, such as, for example, a living hinge (e.g., and in such embodiments, respective lids (e.g., 66) or portions thereof may be unitary and/or integrally formed with respective caps (e.g., 34) and/or portions thereof). In yet other embodiments, respective lids (e.g., 66) may be removable from respective caps (e.g., 34), and respective hinges (e.g., 74) may be omitted. As shown, in this embodiment, cap 34 and/or lid 66 define a latch 84 configured to releasably secure the lid in the closed position.

In the embodiment shown, liquid container 10a comprises a filter assembly 86a configured to filter liquid communicated between interior volume 22 and outlet 46. In this embodiment, filter assembly 86a has a first end 90a, a second end 94a, and a housing 98a extending from the first end to the second end to define an interior passageway 102a configured to contain or, in some embodiments, containing a filter 106. In some embodiments, at least a portion of a respective filter (e.g., 106) (e.g., upper end cap 118, lower end cap 126, filter media 130, and/or the like, components described in more detail below) is unitary and/or integrally formed with at least a portion of a respective housing (e.g., 98a). In the depicted embodiment, housing 98a comprises plastic; however, in other embodiments, respective housings (e.g., 98a) can comprise any suitable material, such as, for example metal, and/or the like. In the embodiment shown, housing 98a substantially cylindrical (FIGS. 1H, 1J); however, in other embodiments, respective housings (e.g., 98a) can comprise any suitable shape, such as, for example, a shape comprising an elliptical and/or otherwise rounded cross-section, a triangular, rectangular, and/or otherwise polygonal cross-section, and/or the like. In this embodiment, housing 98a is spaced apart from sidewall 18 of bottle 14 (e.g., to facilitate liquid flow into filter assembly 86a).

In the depicted embodiment, housing 98a between first end 90a and second end 94a defines a plurality of apertures 110 in fluid communication with interior passageway 102a (FIG. 1I). In the embodiment shown, each of plurality of apertures 110 comprises a substantially circular cross-section; however, in other embodiments, respective apertures (e.g., 110) of respective housings (e.g., 98a) can comprise any suitable cross-section. In this embodiment, each of plurality of apertures 110 has a minimum transverse dimension 114 larger than minimum transverse dimension 58 of outlet 46. In these ways and others, housing 98a may mitigate flow restrictions in liquid flow through filter 106, while retaining the filter within the housing.

In the depicted embodiment, filter 106 comprises an upper end cap 118 defining an opening 122, a lower end cap 126, and a filter media 130 extending the between upper end cap and the lower end cap. In the embodiment shown, lower end cap 126 is closed. In this embodiment, upper end cap 118 and lower end cap 126 each define an (e.g., annular) recess, 134 and 138, respectively, each of the recesses configured to receive at least a portion of filter media 130. In this embodiment, filter 106 comprises a first fitting or open stem 142 extending away from upper end cap 118 opposite recess 134 and surrounding opening 122. In the embodiment shown, first fitting or open stem 142 defines one or more annular grooves 146 (e.g., on an exterior surface and/or on an interior surface of the first fitting or open stem), each configured to receive an O-ring 150. As shown, in this embodiment, opening 122 of filter 106 is off-centered on upper end cap 118 (e.g., is defined by the upper end cap closer to a first side of the upper end cap than to a second side of the upper end cap that is opposite the first side of the upper end cap). In at least this way, filter 106 and/or filter assembly 86a may be substantially laterally centered within interior volume 22, while allowing outlet 46 to be off-centered on cap 34 (e.g., defined by the cap closer to a first side of the cap than to a second side of the cap that is opposite the first side of the cap) (e.g., facilitating a user in drinking from liquid container 10a).

In the depicted embodiment, filter media 130 is generally annular, defining an inner volume 154. For example, in the embodiment shown, filter media 130 comprises a plurality of annularly disposed pleats 158. In this embodiment, filter media 130 comprises carbon-infused fabric having a nominal pore size of less than 0.5 microns. Filter 106 is provided only by way of example, as the present liquid containers may be configured for use with any suitable respective filter (e.g., 106), comprising any suitable respective filter media (e.g., 130) (e.g., metallic alloy filters, ceramic filters, and/or the like), having any suitable nominal pore size.

In the embodiment shown, interior passageway 102a of housing 98a is configured to contain filter 106 such that filter media 130 is spaced apart from the housing (e.g., to facilitate liquid flow into the filter media). In this embodiment, interior passageway 102a is configured to contain filter 106 such that second end 94a of filter assembly 86a is substantially closed. For example, in the depicted embodiment, when filter 106 is received within interior passageway 102a, housing 98a and lower end cap 126 cooperate to substantially close second end 94a of filter assembly 86a (e.g., defining a relatively small annular passageway 162 in communication with the interior passageway of the housing). In these ways and others, filter assembly 86a may be configured to encourage radial liquid flow (e.g., through plurality of apertures 110), as opposed to axial liquid flow, through filter 106, while allowing the filter assembly to collect liquid disposed at the bottom of bottle 14 (e.g., opposite mouth 26).

In the embodiment shown, liquid container 10a comprises a straw 166 configured to be coupled in fluid communication between outlet 46 and opening 122. In this embodiment, straw 166 is configured to be coupled to first fitting or open stem 142 of filter 106. For example, in the depicted embodiment, first fitting or open stem 142 is configured to be received by straw 166; however, in other embodiments, respective straws (e.g., 166) may be received by respective first fittings or open stems (e.g., 142). For further example, in the embodiment shown, cap 34 comprises a second fitting or open stem 170 extending away from the cap opposite mouth piece 50 and surrounding outlet 46. In this embodiment, second fitting or open stem 170 defines one or more annular grooves 174, each configured to receive an O-ring 178. In the depicted embodiment, straw 166 is configured to be coupled to second fitting or open stem 170 of cap 34. For example, in the embodiment shown, second fitting or open stem 170 is configured to be received by straw 166; however, in other embodiments, respective straws (e.g., 166) may be received by respective second fittings or open stems (e.g., 170). As shown, in this embodiment, straw 166 is not configured to retain any O-rings (e.g., the straw does not comprise any grooves, such as, for example, annular grooves 146 and 174 of first fitting or open stem 142 and second fitting or open stem 170, respectively). O-rings (e.g., 150, 178), annular grooves (e.g., 146, 174), and/or the like are provided only by way of example, as embodiments of the present liquid containers may comprise any suitable respective sealing structure(s) (e.g., mechanical seals, and/or the like).

In this embodiment, straw 166 extends into interior passageway 102a of housing 98a. In the depicted embodiment, straw 166 is configured to extend into filter 106 (e.g., into inner volume 154) through upper end cap 118 such that the straw is spaced apart from an innermost surface 182 of filter media 130. In at least this way, some embodiments of the present liquid containers may be configured to, for example, provide for substantially radial liquid flow, as opposed to axial liquid flow, through a respective filter media (e.g., 130), reduce a pressure differential required for liquid flow through the respective filter media, and/or the like. In this embodiment, straw 166 is unitary and/or integrally formed with at least a portion of housing 98a; however, in other embodiments, respective straws (e.g., 166) may be separate components from respective housings (e.g., 98a).

Some embodiments of the present methods comprise providing a filter (e.g., 106) having an upper end cap (e.g., 118) defining an opening (e.g., 122), a lower end cap (e.g., 126), and a filter media (e.g., 130) extending between the upper end cap and the lower end cap to define an inner volume (e.g., 154), disposing a straw (e.g., 166) through the opening and into the inner volume such that the straw is spaced apart from an innermost surface (e.g., 182) of the filter media, disposing the filter through a mouth (e.g., 26) of a bottle (e.g., 14) and into an interior volume (e.g., 22) of the bottle, and disposing a cap (e.g., 34) defining an outlet (e.g., 46) over at least a portion of the mouth such that the outlet is in fluid communication with the straw.

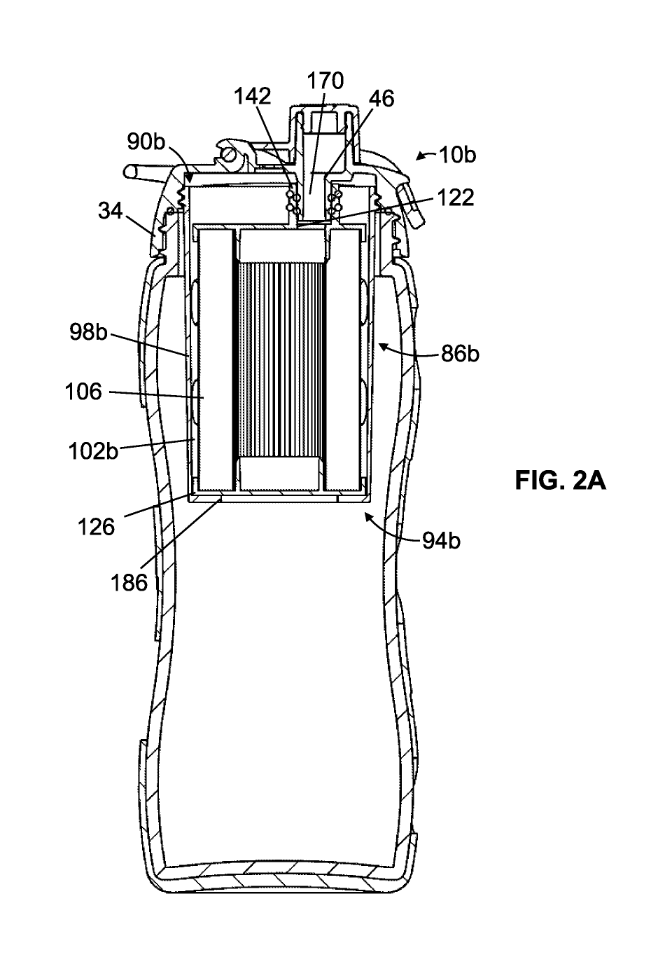

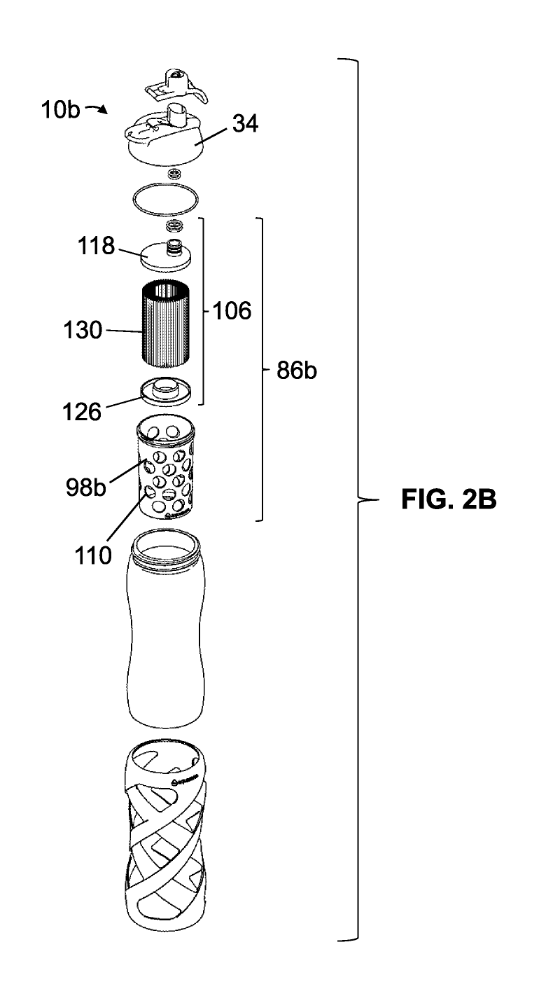

Referring now to FIGS. 2A and 2B, shown therein and designated by the reference numeral 10b is a second embodiment of the present liquid containers. Liquid container 10b is substantially similar to liquid container 10a, with the primary exceptions described below. In the embodiment shown, filter assembly 86b is configured to be coupled to cap 34 (e.g., without straw 166) such that opening 122 of filter 106 is in fluid communication with outlet 46. For example, in this embodiment, first end 90b of filter assembly 86b is configured to be threadably coupled to cap 34 (e.g., as shown, via threads on housing 98b of filter assembly 86b and cap 34); however, in other embodiments, respective filter assemblies (e.g., 86b) can be coupled to respective caps (e.g., 34) in any suitable fashion, such as, for example, via a press-fit, snap-fit, interlocking features of the respective filter assemblies and/or the respective caps, and/or the like.

In the depicted embodiment, first fitting or open stem 142 is configured to be coupled to cap 34. For example, in the embodiment shown, second fitting or open stem 170 of cap 34 is configured to be coupled first fitting or open stem 142 of filter 106. In this embodiment, first fitting or open stem 142 is configured to receive second fitting or open stem 170. In this way, for example, some embodiments of the present liquid containers may be modular in nature (e.g., configured for use with and/or without straw 166). However, in other embodiments, respective second fittings or open stems (e.g., 170) may be configured to receive respective first fittings or open stems (e.g., 142).

In the embodiment shown, interior passageway 102b of housing 98b is configured to contain filter 106 such that second end 94b of filter assembly 86b is closed. For example, in this embodiment, second end 94b of filter assembly 86b (e.g., housing 98b) defines an opening 186, and lower end cap 126 of filter 106 is configured to cover opening 186 when filter 106 is received within interior passageway 102b.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

What is claimed is:

1. A liquid container comprising:
a bottle having a sidewall defining an interior volume configured to hold liquid and a mouth in fluid communication with the interior volume;
a cap defining a recess configured to receive a portion of the bottle to cover at least a portion of the mouth, the cap defining an outlet in fluid communication with the interior volume; and
a filter assembly configured to filter liquid communicated between the interior volume and the outlet, the filter assembly having:
a first end;
a second end; and
a housing extending from the first end to the second end to define an interior passageway configured to contain a filter having:
an upper end cap defining an opening;
a lower end cap; and
a filter media extending between the upper end cap and the lower end cap; and
a straw configured to be coupled in fluid communication between the outlet and the opening such that the straw extends into the interior passageway of the housing.

2. The liquid container of claim 1, where the straw is configured to extend through the upper end cap of the filter such that the straw is spaced apart from an innermost surface of the filter media.

3. The liquid container of claim 1, where the interior passageway of the housing is configured to contain the filter such that the second end of the filter assembly is substantially closed.

4. The liquid container of claim 1, where the straw is unitary with at least a portion of the housing.

5. The liquid container of claim 1, where:
the filter comprises a first fitting extending away from the upper end cap and surrounding the opening, the first fitting defining one or more annular grooves, each configured to receive an O-ring; and
the first fitting is configured be coupled to the straw.

6. The liquid container of claim 5, where the first fitting is configured to be received by the straw.

7. The liquid container of claim 1, where:
the cap comprises a second fitting extending away from the recess and surrounding the outlet, the second fitting defining one or more annular grooves, each configured to receive an O-ring; and
the second fitting is configured to be coupled to the straw.

8. The liquid container of claim 7, where the second fitting is configured to be received by the straw.

9. The liquid container of claim 1, where the housing between the first end and the second end defines a plurality of apertures in fluid communication with the interior passageway.

10. The liquid container of claim 9, where each of the plurality of apertures has a minimum transverse dimension larger than a minimum transverse dimension of the outlet.

11. A liquid container comprising
a bottle having a sidewall defining an interior volume configured to hold liquid and a mouth in fluid communication with the interior volume;
a cap defining a recess configured to receive a portion of the bottle to cover at least a portion of the mouth, the cap defining an outlet in fluid communication with the interior volume; and
a filter assembly configured to filter liquid communicated between the interior volume and the outlet, the filter assembly having:
a first end;
a second end; and
a housing extending from the first end to the second end to define an interior passageway configured to contain a filter having:
an upper end cap defining an opening;
a lower end cap; and
a filter media extending between the upper end cap and the lower end cap;
where the housing between the first end and the second end defines a plurality of apertures in fluid communication with the interior passageway, each of the plurality of apertures having a minimum transverse dimension larger than a minimum transverse dimension of the outlet;
where the filter assembly is configured to be coupled to the cap such that the opening of the filter is in fluid communication with the outlet.

12. The liquid container of claim 11, where the interior passageway of the housing is configured to contain the filter such that the second end of the filter assembly is closed.

13. The liquid container of claim 11 where:
the filter comprises a first fitting extending away from the upper end cap and surrounding the opening, the first fitting defining one or more annular grooves, each configured to receive an O-ring; and
the first fitting is configured to be coupled to the cap.

14. The liquid container of claim 11, where:
the cap comprises a second fitting extending away from the recess and surrounding the outlet, the second fitting defining one or more annular grooves, each configured to receive an O-ring; and
the second fitting is configured to be coupled to the upper end cap of the filter.

15. The liquid container of claim 11, where the first end of the filter assembly is configured to be press-fit to the cap.

16. The liquid container of claim 11, where the first end of the filter assembly is configured to be threadably coupled to the cap.

17. The liquid container of claim 11, where each of the plurality of apertures comprises a substantially circular cross-section.

18. The liquid container of claim 1, where the housing of the filter assembly is substantially cylindrical.

19. The liquid container of claim 1, where the housing of the filter assembly is spaced apart from the sidewall of the bottle.

20. The liquid container of claim 1, where the interior passageway of the housing is configured to contain the filter such that the filter media is spaced apart from the housing.

21. The liquid container of claim 1, further comprising a filter.

22. The liquid container of claim 21, where at least a portion of the filter is unitary with at least a portion of the housing of the filter assembly.

23. The liquid container of claim 1, where the upper end cap of the filter and the lower end cap of the filter each define a recess configured to receive at least a portion of the filter media.

24. The liquid container of claim 23, where the recess of each of the upper end cap and the lower end cap is annular.

25. The liquid container of claim 1, where the lower end cap of the filter is closed.

26. The liquid container of claim 1, where the filter media has a nominal pore size of less than 0.5 micron.

27. The liquid container of claim 1, where the filter media comprises pleated fabric.

28. The liquid container of claim 27, where the pleated fabric comprises carbon.

29. The liquid container of claim 1, where the cap is configured to be threadably coupled to the bottle.

30. The liquid container of claim 1, where the cap comprises a vent configured to adjust an internal pressure of the bottle.

31. The liquid container of claim 1, where the cap comprises a mouth piece in fluid communication with the outlet.

32. The liquid container of claim 31, where the mouth piece is laterally offset from the outlet.

33. The liquid container of claim 1, comprising a lid pivotally coupled to the cap, the lid configured to selectively cover the outlet.

34. A method comprising:
providing a filter having a upper end cap defining an opening, a lower end cap, and a filter media extending between the upper end cap and the lower end cap to define an inner volume;
disposing a straw through the opening and into the inner volume such that the straw is spaced apart from an innermost surface of the filter media;
disposing the filter through a mouth of a bottle and into an interior volume of the bottle; and
disposing a cap defining an outlet over at least a portion of the mouth such that the outlet is in fluid communication with the straw.
